(19) United States
(12) Patent Application Publication
(10) Pub. No.: US 2013/0323057 A1
(43) Pub. Date: Dec. 5, 2013

(54) APPARATUS FOR MEASURING ICE DEPOSITION ON THE ROTOR BLADES OF A WIND TURBINE

(71) Applicant: Hainzl Industriesysteme GmbH, Linz (AT)

(72) Inventors: Thomas BUCHEGGER, Dietach (AT); Clemens HESCH, Linz (AT)

(21) Appl. No.: 13/909,249

(22) Filed: Jun. 4, 2013

(30) Foreign Application Priority Data
Jun. 5, 2012 (AT) A 50221/2012

(51) Int. Cl. F03D 11/00

(52) U.S. Cl. CPC F03D 11/0025
USPC 416/61

(57) ABSTRACT

An apparatus is described for measuring the deposition of ice on the rotor blades (5) of a wind turbine (1), having a transmitting and receiving device with parts that are on the rotor blades (5) on the one hand and parts that are arranged in fixed positions and are connected to each other via a wireless transmission link on the other and having an evaluation circuit (9) connected to the transmitting and receiving device. In order to provide advantageous structural conditions, it is proposed that the transmitting and receiving device comprises passive transponders (6) on the rotor blades (5) and at least one stationary reader unit (7) for the transponders (6) and the evaluation circuit (9) has a comparator stage (10) for the minimum transmission output of the reader unit (7) required to read the transponders (6) reliably, with a programmable threshold value for this transmission output in the event of the deposition of ice.

The invention relates to an apparatus for measuring ice deposition on the rotor blades of a wind turbine provided with a transmitting and receiving device with parts that are on the rotor blades on the one hand and parts that are arranged in fixed positions and connected to each other via a wireless transmission link on the other and having an evaluation circuit connected to the transmitting and receiving device.

Apart from the additional load on the rotor blades of a wind turbine resulting from the deposition of ice, such ice deposits, which form on the surface of the rotor blades facing the incident air flow, alters the flow profile in such a way that the efficacy of the wind turbine is likely to be impaired. Consequently, monitoring of the rotor blades for possible ice formation assumes considerable significance in the operation of wind turbines. Various measures for monitoring rotor blades with respect to ice formation are known. For example, measuring the mass ratios of the rotor blades has already been proposed (DE 10 2005 016 524 A1), for example by using the bending moment at the root of the blades. The mass ratios change with the deposition of ice as well as with the meteorological conditions in conjunction with the risk of ice. Not only does this involve considerable resources, but only provides measurement results once the mass ratios change sufficiently for measurement to occur following substantial ice formation.

Another option (DE 10 2006 032 387 A1) involves measuring the formation of ice optically with the aid of laser beams that are directed along the surface of the rotor blades on which ice tends to form, with the capacity to represent a parameter for ice formation on the basis of the interaction with the ice formed on the surface. On the other hand, the disadvantage is the relative lack of sensitivity when measuring the film of ice being formed. Furthermore, provision needs to be made for design elements on the rotor blades that need to be supplied with power.

A further known method for monitoring ice formation on rotor blades (DE 10 2005 017 054 A1) monitors the oscillatory response of the rotor blades, which changes when ice forms. For this purpose, the structure-borne sound of the rotor blades is measured in selected frequency ranges at various points and monitored for characteristic changes in order to measure ice formation. Similarly, this method is likely to involve relatively high structural costs.

Furthermore, DE 4023982 A1 makes known the provision of electrical oscillatory circuits on rotor blades to monitor the oscillatory response of the rotor blades of a turbine when water or ice forms a deposit on them. The oscillatory circuits are activated to resonate using a stationary vibration generator in order to be able to infer the existence of water or ice deposits on the basis of changes in the characteristics of these oscillatory circuits.

In order to be able to measure data from a rotor blade of a wind turbine wirelessly DE 10 2007 001 507 A1 also makes known the provision of passive transponders on rotor blades that can be read via a stationary polling device. If a transponder fails for example because it is struck by lightning, this can be measured by means of the polling device, which then issues a warning correspondingly. Transponders are also employed on the rotor blades of wind turbines to measure the individual positions of the points of the rotor blades provided with the transponders, enabling conclusions to be drawn with respect to the proper functionality of the rotor blades. In all these cases, the transponders are used to transmit data wirelessly, but they do not permit any conclusions to be drawn with respect to the formation of ice.

Consequently, the aim of the invention is to design an apparatus to monitor the rotor blades of a wind turbine with respect to the formation of ice deposits such that the reliable measurement of ice deposits is possible with simple structural means, without having to provide energy sources on the rotor blades.

Based on an apparatus of the type described above for measuring ice deposits on rotor blades of a wind turbine, the invention fulfils the stated aim in that the transmitting and receiving device comprises passive transponders on the rotor blades and at the least one stationary reader unit for the transponders, Furthermore, the evaluation circuit has a comparator stage for the minimum reader unit transmission output required to read the transponder reliably, with a programmable threshold value for this transmission output in the event of ice deposits forming.

The invention is based on the knowledge that the electric field radiated by the reading device will be damped when a layer of ice covers a passive transponder, meaning that a possible deposition of ice can be measured reliably on the basis of such damping. This only requires a threshold value to be specified for the transmission output required to actuate the passive transponder in the event of an ice deposit in order to check whether the minimum reading device transmission output required for reliable transponder reading lies above or below this threshold value. If the minimum transmission output of the reading device lies under the specified threshold value required for a reliable read, this means there can be no deposition of ice meeting the threshold value. If the transmission output reaches the specified minimum threshold value required to read the transponder reliably, this means that there is an ice deposit in the area of the transponder accordingly. In the simplest case, the threshold value can be specified empirically and chosen subject to the sensitivity of monitoring required in each case. As the power to read the passive transponders is transmitted to the transponders via the electrical field transmitted by the reader unit and the transponders are only activated once sufficient electrical energy is received, the structural design is simple, particularly as the passive transponders can be easily attached to the places on the rotor blades that are susceptible to ice formation accordingly.

In order to ensure the sensitivity of monitoring for ice formation on the rotor blades of a wind turbine, the transmission output of the reading unit can at least be magnified incrementally by means of a control device subject to transponder actuation so that the minimum reading unit transmission output to be provided for transponder read-out can be measured reliably. Therefore, all that is required is a suitable evaluation circuit in a comparator stage to compare the transmission output of the reader unit recorded when the transponder is actuated with the specified threshold value for this transmission output in the event of an ice deposit and to indicate ice formation as a function of this.

The drawing illustrates exemplary embodiments of the invention.

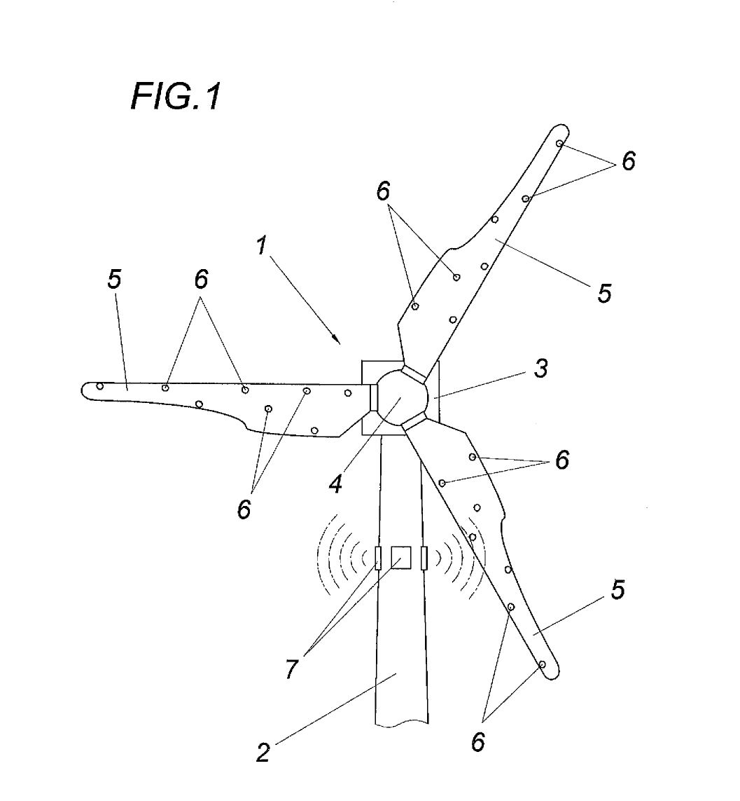

FIG. 1 shows a schematic view of a wind turbine with an apparatus according to the invention for measuring the deposition of ice on rotor blades and

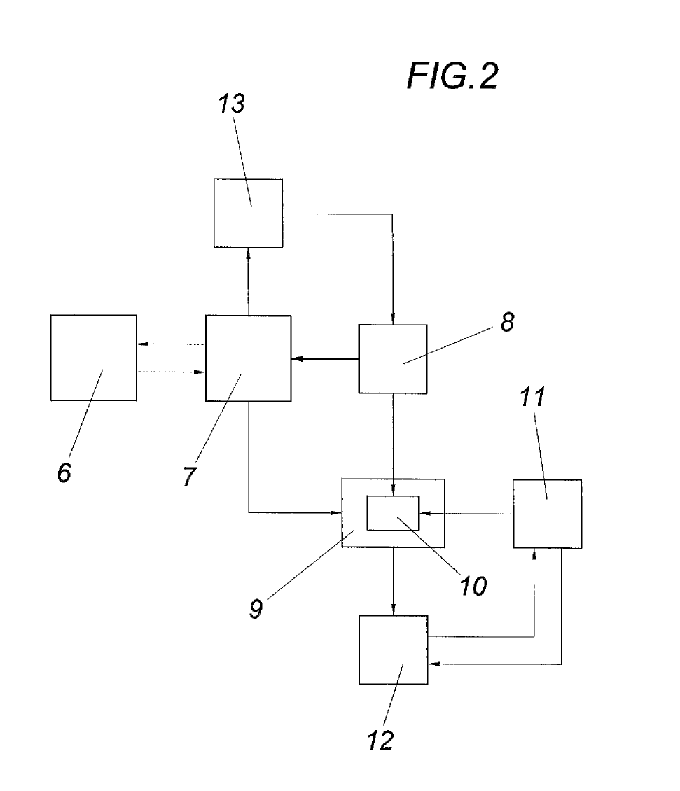

FIG. 2 shows a schematic functional block diagram of such an apparatus according to the invention.

FIG. 1 shows a wind turbine 1 on a stand 2 that bears a housing 3 for a turbine rotor 4, with the former able to be rotated about a vertical axis. The rotor blades 5 are provided with passive transponders 6, distributed over the surface areas of the rotor blades 5 that are susceptible to icing. In order to read these transponders 6, provision is made for reader units 7 to be distributed over the circumference of the stand 2 to take the orientation of the turbine rotor 4 with respect to the wind into account and to ensure a read out from the transponders 6 via at least one of the reader units 7 for each rotational position of the housing 3 relative to the stand 2.

According to FIG. 2, electrical energy impinges on each reader unit 7 via an amplifier 8 that provides the minimum transmission output required for reading the passive transponders 6. This minimum transmission output required to read the transponders 6 reliably is evaluated in an evaluation circuit 9 for measuring possible ice formation in the area of one of the transponders 6. This is done by comparing this minimum transmission output for reading the transponder 6 reliably with a threshold value stored in a memory 11 in a comparator stage 10 of the evaluation circuit 9. The threshold value corresponds to the minimum transmission output required to read the transponder 6 in the event of an ice deposit to be measured. If the transmission output required to activate the transponders 6 lies under this threshold value in each case, then there is no deposition of ice to be measured. However, if this threshold value is exceeded then there is an ice deposit to be addressed, something indicated in the display and input stage 12 connected to the evaluation circuit 9. Each transmission output threshold value can be imported into the memory 11 via this display and input stage 12.

If the transmission output set via the amplifier 8 of the reader unit 7 of the transponder 6 cannot be read, then the transmission output is increased at least incrementally via the amplifier 8. To this end, a control device 13 is fed via the reader unit 7, with said control device actuating the amplifier 8 in the sense that it increases the output for the reader unit 7. If this transmission output is sufficient to read the passive transponder 6, the evaluation circuit 9 connected to the reader unit 7 receives the target value for this transmission output in order to be able to assess the possible formation of ice by comparing it with the specified threshold value for this output. If the transponder 6 cannot be read yet, the transmission output is further increased using the control device 13 until the passive transponder 6 is actuated and can be read.

In order to measure the formation of ice on the rotor blades 5 it is sufficient to read an identifier for the individual transponders 6. This is because the position of the transponder 6 on each specific rotor blade 5 can be determined using the transponder identifier, such that initial ice formation on the rotor blade 5 can be localised when the rotor blade 5 moves past the stationery reader unit in each case. Due to the limitations of the transmission link as a result of the use of passive transponders 6, under certain circumstances it may be necessary to make provision for a plurality of reader units 7 to be distributed over the height of the stand 2 for the transponders 6 distributed over the rotor blades 5.

1. Apparatus for measuring ice deposition on the rotor blades (5) of a wind turbine (1), having a transmitting and receiving device consisting of parts that are arranged on the rotor blades (5) on the one hand and parts that are arranged in fixed positions and connected to each other via a wireless transmission link on the other and having an evaluation circuit (9) connected to the transmitting and receiving device, wherein the transmitting and receiving device comprises passive transponders (6) on the rotor blades (5) and at least one stationary reader unit (7) for the transponders (6) and the evaluation circuit (9) has a comparator stage (10) for the minimum transmission output required by the reader unit (7) to read the transponder (6) reliably, with a programmable threshold value for this transmission output in the event of ice deposition.

2. Device in accordance with claim 1, wherein the transmission output of the reader unit (7) can be magnified at least incrementally by means of a control device (13) subject to actuation of the transponders (6).
